(19) United States
(12) Patent Application Publication
(10) Pub. No.: US 2026/0260064 A1
(43) Pub. Date: Sep. 3, 2026

(54) PERPLEXITY GUIDED ATTENTION FOR LANGUAGE MODELS

(71) Applicant: BMC Helix, Inc., Houston, TX (US)

(72) Inventors: Vikas Prasad, Pune (IN); Ajoy Kumar, Santa Clara, CA (US); Siva Sai Nellore, Bangalore (IN)

(21) Appl. No.: 19/067,738

(22) Filed: Feb. 28, 2025

(51) Int. Cl. G06F 40/284

(52) U.S. Cl. CPC G06F 40/284

(57) ABSTRACT

Systems and techniques enable processing a prompt at a language model to generate a first output in response to the prompt, and determining, for the first output, at least a first potential next token and a second potential next token. A first perplexity score may be determined for the first potential next token with respect to the first output and a second perplexity score may be determined for the second potential next token with respect to the first output. The first potential next token may be selected as a next token, based on the first perplexity score and the second perplexity score, and a second output may be provided from the language model that includes the next token appended to the first output.

### TECHNICAL FIELD

This description relates to language models.

### BACKGROUND

Conventional language models, such as large language models, are trained using training data, such as a corpus of documents. In some cases, a large language model is pre-trained with a very large corpus of documents or other training data, and then fine-tuned with respect to more defined or more specific subject matter. More generally, a large language model may be iteratively trained or otherwise modified over time to improve its performance.

Such language models are prone to a technical problem known as hallucination. Hallucination generally refers to the outputting of erroneous or spurious information by a language model.

For example, large language models, at a high level, output sentences by choosing a subsequent word based on a current word and preceding words, and in accordance with their training and a received prompt. Hallucination may occur, for example, when such a language model has not been sufficiently or adequately trained. For example, a language model that has been fine-tuned with respect to a particular domain may not have been provided with sufficient training or sufficient training data with respect to the domain in question.

As language models produce outputs word-by-word and sentence-by-sentence, a language model that hallucinates may provide output that is correctly structured and grammatically correct, but that is factually inaccurate or otherwise problematic. Consequently, users may receive outputs that are either clearly unhelpful or wrong, or that appear to provide desired information while actually providing false information.

### SUMMARY

In some aspects, the techniques described herein relate to a computer-implemented method including processing a prompt at a language model to generate a first output in response to the prompt, and determining, for the first output, at least a first potential next token and a second potential next token. The computer-implemented method further includes determining a first perplexity score for the first potential next token with respect to the first output and a second perplexity score for the second potential next token with respect to the first output, selecting the first potential next token as a next token, based on the first perplexity score and the second perplexity score, and providing a second output from the language model that includes the next token appended to the first output.

According to other general aspects, a computer program product may perform the instructions of the computer-implemented method. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for perplexity guided attention for language models.

FIG. 2 is an example process illustrating example operations of the system of FIG. 1.

FIG. 3 is an example schematic of a large language model with attention heads.

FIG. 4 is an example schematic of a large language model with attention heads having perplexity-adjusted probabilities a final attention layer.

FIG. 5 is a flowchart of a more detailed example of the system of FIG. 1.

### DETAILED DESCRIPTION

As referenced above, a large language model (LLM) is a deep learning algorithm that can perform a variety of natural language processing tasks. A large language model is a type of generative artificial intelligence that is trained using large text datasets to produce and output content, such as textual content. For example, a large language model can be used to receive an input, to process the input, and to output a text summarization, text generation, text classification, or answers to questions, to name just a few example processing and output types.

In some implementations, a large language model uses a transformer model that is trained using very large datasets. This enables the large language model to recognize, translate, predict, or generate text or other content. The transformer model includes an encoder and a decoder. The transformer model processes data by tokenizing the input, then simultaneously performing mathematical operations to determine relationships between tokens. The transformer model works with self-attention mechanisms, which enables the transformer model to learn more quickly than other models. For example, the self-attention mechanisms enable the transformer model to consider different parts of the text sequence, or the entire context of a sentence, to generate predictions.

In more specific examples, a large language model will generate, in response to a received prompt, existing words in a partial sentence and then generate potential next words, where each potential next word is associated with a probability of being the best word choice to extend or complete the sentence. In a highly simplified example, a large language model may consider the partial sentence, “The man from Germany spoke . . . ”, and may predict potential next words and associated probabilities that include: German (0.4), French (0.2), English (0.19). Consequently, the language model may choose “German” as having the highest probability (0.4) and thus the most likely word to complete the sentence.

When associated probabilities of potential next words are approximately equal, the large language model may be prone to hallucination, as referenced above. For example, the large language model may receive a query or prompt and may begin to output a response. As the large language model constructs the response, it chooses between potential next words, as just described. When the potential next words have approximately equal probabilities, the large language model may select a word that is not correct with respect to the received query or prompt. Since the large language model constructs responses progressively, a subsequent next word may also be incorrect, so that entire sentences of the response of the large language model, or the entire response, may be incorrect.

In order to minimize or avoid hallucinations, described techniques provide the technical solution of adjusting probabilities of potential next words, so that a corresponding large language model is more likely to be correct when selecting a next word from potential next words. For example, in the simplified example above, a conventional large language model may encounter potential next words with probabilities of: German (0.322), French (0.32), English (0.318). With the associated probabilities being so close to one another, the large language model may be prone to the types of hallucination referenced above.

Using described techniques, however, the probabilities may be adjusted to the examples provided above of: German (0.4), French (0.2), English (0.19). Consequently, the potential next word ‘German’ is more clearly distinguished as being the best next word for the large language model to select.

In order to provide the above-referenced types of probability adjustments to potential next words, described techniques use one or more confidence metrics to guide one or more attention layers of the large language model. For example, attention layers may be included in an attention head of the large language model architecture. In an example, the large language model may be organized in a transformer architecture having multiple parallel layers known as attention heads. In some examples, each separate attention head may process an input sequence and an associated output sequence element, using one or more attention layers. As described in more detail below, such attention layers are associated with outputting potential next words and corresponding probabilities.

In example implementations, confidence metrics used to adjust these probabilities may include, or be based on, a metric known as perplexity, or a perplexity metric. Perplexity is a metric conventionally used during training of a large language model to quantify a degree of uncertainty expressed by the large language model when encountering a new input and providing a corresponding output.

For example, as referenced above, a large language model may be subjected to multiple iterations of training, such as when fine-tuning a model and/or upon receipt of new training data. To determine whether such iterative training results in improvements to the model being trained, various metrics, including perplexity, are used to quantify the performance of each iteration of a model. For example, as a model undergoes multiple iterations of training, one or more perplexity scores may be calculated at each iteration. If the perplexity scores show improvement over the course of the iterations, then the training is considered to show improvement, and a final iteration of the large language model is considered to be improved with respect to the initial iteration.

Described techniques provide technical solutions to the technical problem of model hallucination by using perplexity related metrics or scores to adjust outputs of one or more attention layers of a large language model, so that corresponding attention weights or probabilities are also adjusted, as referenced above. For example, when generating a next word from a set of potential next words using a language model, each and all of the set of potential next words may be associated with a probability of being the best or correct word to choose.

For example, described techniques may process an existing partial output of the language model with respect to each of a set of potential next words (and the corresponding probability of each potential next word to be the actual or selected word) to determine a perplexity score for each combination of the partial output and each one of the potential next words. Each probability of each corresponding potential next word (in the context of the partial output) may thus be considered to provide a word-specific perplexity score. These word-specific perplexity scores may then be used to adjust probabilities (e.g., attention weights) of the potential next words in the manner referenced above, and described in more detail, below.

For example, in the simplified example above, a partial output of “The man from Germany spoke” may be associated with the potential next words and associated probabilities of: German (0.322), French (0.32), English (0.318). Described techniques may be used to calculate word-specific perplexity scores for each potential next word in the context of the partial output. For example, a perplexity score may be calculated for “The man from Germany spoke German,” “The man from Germany spoke French,” and “The man from Germany spoke English.” Resulting word-specific perplexity scores may be used to adjust attention weights, and probabilities, of the potential next words, to thereby result in potential next words and associated perplexity-guided probabilities of: German (0.4), French (0.2), English (0.19), so that ‘German’ is more clearly the best next word of the potential next words to select.

In this way, described techniques take into account a context of a partial output when generating a next word to be included in the output of a large language model. For example, if the partial output is “While in France, the man from Germany spoke”, then potential next words and associated probabilities may initially be generated as: German (0.22), French (0.32), English (0.28). Following perplexity-guided adjustments, the potential next words and associated probabilities may be determined to be: German (0.2), French (0.5), English (0.2), so that the next word of ‘French’ is more easily distinguished and selected.

As described in detail, below, technical solutions provided herein do not require additional training or additional training data for implementation. Instead, outputs of virtually any language model may be improved through the use of perplexity-related metrics. Moreover, related calculations for calculating and using such perplexity-related metrics are mathematically compact and easy to calculate, and do not add appreciably to existing calculations performed by underlying large language model(s). As a result, described techniques may be used to improve performances of large language models, including reducing or eliminating hallucinations, with minimal or negligible effects on processing time and/or associated processing resources.

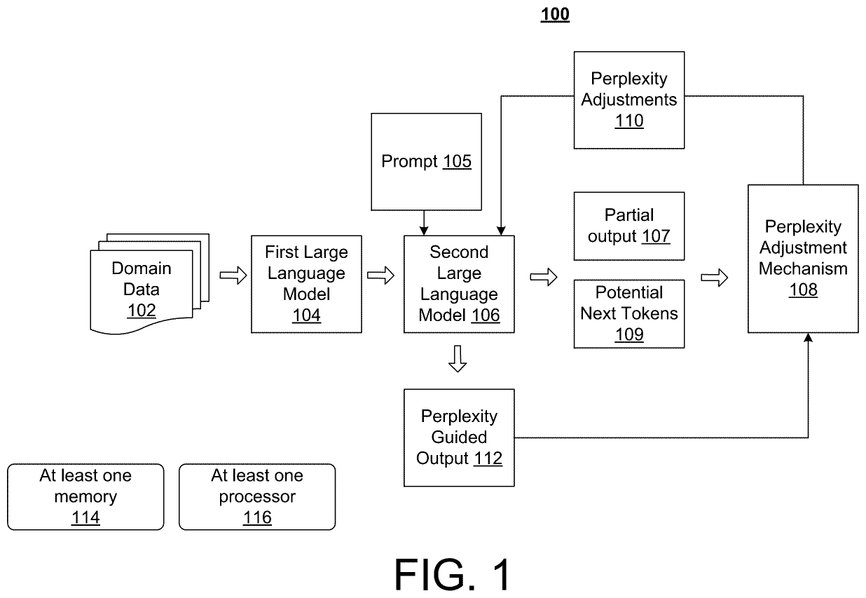

FIG. 1 is a block diagram of a system 100 for perplexity-guided attention for large language models. The system 100 includes domain data 102, a first large language model 104, a second large language model 106, and a perplexity adjustment mechanism 108.

In the system 100, the domain data 102 is representative of data that is specific to a particular domain. Domain data 102 includes a specific category of data such as, for example, customer data, supplier data, product data, employee data, asset data, financial data, reference data, system data, and/or location data. More specifically, for example, the domain data 102 may include information technology service management (ITSM) data such as ITSM ticket data. In another example, the domain data 102 may include software and/or hardware application log data.

The domain data 102 includes a representative dataset containing data, such as the types of data listed above, that are relevant to the domain of interest. In some implementations, the domain data 102 may be preprocessed. For example, the domain data 102 may be preprocessed by tokenizing, cleaning, and/or encoding the data in such a manner that it may be used and processed by the first large language model 104.

In some implementations, the first large language model 104 may include a generic or off-the-shelf large language model. The first large language model 104 may be referred to as the original large language model. The first large language model 104 may be considered a pre-trained model, but one that is not considered fine-tuned. The domain data 102 is used to train and fine tune the first large language model 104 so that the first large language model 104 is relevant to the domain of interest.

To fine tune and train the first large language model 104, the domain data 102 is input to the first large language model 104. The first large language model 104 receives the domain data 102. Fine tuning the first large language model 104 includes adjusting parameters of the first large language model 104 using the domain data 102. The process of fine tuning the first large language model 104 enhances the first large language model 104 to understand and generate content pertinent to the domain. The output of fine tuning the first large language model 104 using the domain data 102 is the second large language model 106.

The second large language model 106 is a fine tuned, large language model that understands and generates content pertinent to the domain of the domain data 102. In the preceding description, inputs and outputs of language models are referred to generally as words, for ease of explanation and understanding. More generally, and as discussed in more detail, below, language models may be considered to input and output tokens, where a token is considered a unit of data. Thus, a token may include a word, a subword (e.g., “run” in the word “running”), a number, or any alphanumeric text. Tokens may also include special characters (e.g., symbols like “@”, “#”, or “&” can each be a separate token). Tokens may also include punctuations or whitespaces. In the following description, reference may be made to tokens, or, in some examples, to words. Where reference is made to words, it will be appreciated that the more general unit of token is applicable, as well, unless stated otherwise.

In FIG. 1, the second large language model 106 is illustrated as receiving a prompt 105 and providing a partial output 107 and potential next tokens 109. For example, the prompt 105 may include a query or request received as input by the second large language model 106, such as, e.g., a request to provide information about a specified group of people. Then, as described above, the partial output 107 may include a partial sentence, such as: “The man from Germany spoke”. That is, the second language model 106 may iteratively or progressively output each word of the partial output 107, either in a normal fashion for large language models, or using the perplexity-guided techniques described herein.

After outputting the partial output 107, the second large language model 106 may generate a set of potential next tokens 109 and associated probabilities, such as German (0.322), French (0.32), English (0.318). The perplexity adjustment mechanism 108 may be configured to calculate token-specific perplexity scores for each of the potential next tokens 109. These token-specific perplexity scores may be used to provide perplexity adjustments 110, which may then be used to adjust attention weights, and probabilities, of the potential next tokens 109. This process may result in perplexity-guided potential next tokens 109 and associated probabilities of: German (0.4), French (0.2), English (0.19). Consequently, a perplexity guided output 112 of the second large language model 106 may be provided as “The man from Germany spoke German.”

In order to provide the perplexity adjustments 110, the perplexity adjustment mechanism 108 may be configured to calculate a token-specific perplexity score for each potential next token 109, in the context of the partial output 107. For example, as described in more detail, below, a perplexity score is typically calculated for, and applied to, a sequence of tokens output by a large language model.

In contrast, described techniques calculate perplexity scores for multiple combinations of the partial output 107 and each of the potential next tokens 109. For example, each of “German”, “English”, and “French” may be paired with the partial output “The man from Germany spoke” and may each thereby receive a corresponding token-specific perplexity score. Thus, each token-specific perplexity score may leverage, or be calculated using or relative to, an entirety of the partial output 107.

As a result, the token-specific perplexity scores may be used to provide the perplexity adjustments 110 with respect to corresponding attention weights of an attention layer of the second large language model 106. That is, the second large language model 106 may use known self-attention mechanisms to determine a relative importance or context of individual words or portions of the prompt 105 and of the partial output 107, to thereby generate a set of potential next tokens 109 and associated probabilities (e.g., German (0.322), French (0.32), English (0.318)). Provided perplexity adjustments 110 may thus include word-for-word adjustments of attention weights of the words of the potential next tokens 109, to thereby cause the second large language model 106 to output updated probabilities for the potential next words (e.g., German (0.4), French (0.2), English (0.19)), so that the second large language model 106 will automatically output the perplexity guided output 112 (e.g., “German”).

FIG. 1 is illustrated as having a singular partial output 107 and a singular perplexity guided output 112. Of course, in practice, the second large language model 106 may be configured to output successive words and sentences, so that, for example, the perplexity guided output 112 may be provided to the perplexity adjustment mechanism 108 as a second partial output and used to generate second perplexity adjustments, to thereby obtain a second perplexity guided output. Such processing may continue until the second large language model 106 completes its generated output (e.g., reaches a final instance of the perplexity guided output 112).

The examples provided above, and generally herein, are simplified examples for the sake of illustration and explanation and should not considered to be limiting. For example, the partial output 107 refers to any output of the second large language model 106 that exists prior to a completion of a generated output by the second large language model 106. The partial output 107 may thus be a partial sentence or a complete sentence, or may include a list of words, a table or graph, or any other potential output of the second large language model 106 that may be generated in response to the prompt 105.

For purposes of the simplified example of FIG. 1, the perplexity adjustments 110 and corresponding operations of the perplexity adjustment mechanism 108 are described at a high level. In more detailed examples, perplexity may be calculated as the exponential of the average negative log-likelihood of a set, normalized by the number of words or tokens, e.g., as an exponential of negative log probabilities of a sequence of tokens. Expressed mathematically, the probability of a sequence of words W=w₁, w₂, . . . , w_{N} may be expressed by (P(W)), and perplexity (PP) may be defined as shown in Equation 1:

$$PP ( W ) = e {\text{?}}^{{\sum }_{i = 1}^{N} log P} \text{?}$$

$$\text{?} \text{indicates text missing or illegible when filed}$$

Other formulations for perplexity may exist and may be used, as well. In general, perplexity (or perplexity score or perplexity metric, or similar terms) should be understood to refer to, or include, any confidence measure of an output of a language model expressed with respect to a cumulative, average, aggregated, or otherwise characterized series of probabilities of tokens of the output. Such confidence measures may include confidence measures derived from, or computed using, Equation 1 or a similar or corresponding equation. Described techniques utilize such confidence measures with respect to each of a plurality of potential next tokens 109 (and associated probabilities), in the context of an existing series of tokens.

In the simplified example of FIG. 1, such an existing series of tokens is expressed as the simple partial output 107 of, e.g., “The man from Germany spoke”. In other examples, however, the partial output 107 may include, e.g., longer sentences, multiple sentences, paragraphs, or one or more pages of text. More generally, a size or length of the partial output 107 may be a selectable design parameter of the system 100 of FIG. 1, which may vary within or among implementation instances of the system 100 of FIG. 1. More detailed examples of the perplexity adjustments 110 and corresponding operations of the perplexity adjustment mechanism 108 are provided below.

The system 100 may be implemented by at least one computing device, where the at least one computing device may include at least one memory 114 and at least one processor 116. The at least one processor 116 may represent two or more processors executing in parallel and utilizing corresponding instructions stored using the at least one memory 114. The at least one processor 116 may include at least one CPU. In some implementations, the at least one processor 116 may include at least one GPU. The at least one memory 114 represents a non-transitory computer-readable storage medium. Of course, similarly, the at least one memory 114 may represent one or more different types of memory utilized by the system 100. In addition to storing instructions, which allow the at least one processor 116 to implement the system 100, the at least one memory 114 may be used to store data and other information used by and/or generated by the system 100. The at least one memory 114 may be used to store one or more of the first large language model 104 and/or the second large language model 106.

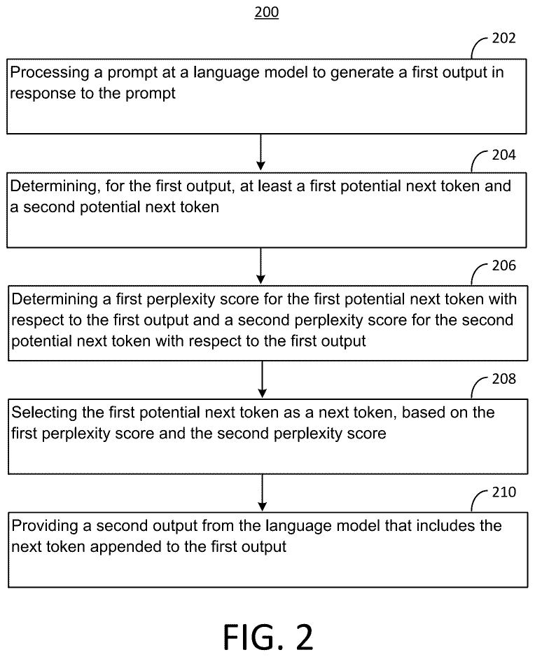

FIG. 2 is an example process 200 illustrating example operations of the system 100. Process 200 is a computer-implemented method that may be implemented by the system 100 and its components. Instructions and/or executable code for the performance of process 200 may be stored in the at least one memory 114, and the stored instructions may be executed by the at least one processor 116. Process 200 is also illustrative of a computer program product that may be implemented by the system 100.

In the example of FIG. 2, example operations are illustrated as separate, sequential operations. However, in various example implementations, the operations may be implemented in a different order than illustrated, in an overlapping or parallel manner, and/or in a nested, iterative, looped, or branched fashion. Further, various operations or sub-operations may be included, omitted, or substituted.

Process 200 includes processing a prompt at a language model to generate a first output in response to the prompt (202). In the example of FIG. 1, the second large language model 106 receives the prompt 105 and outputs the partial output 107 as the first output. In other examples, the prompt 105 may be received at the first large language model 104, and the second large language model 106 may be omitted.

Process 200 includes determining, for the first output, at least a first potential next token and a second potential next token (204). For example, in FIG. 1, the second large language model 106 may determine a probability distribution of potential next tokens 109. That is, at least a first potential next token may be assigned a first probability of selection, while at least a second potential next token may be assigned a second probability of selection. As referenced above, and described in more detail, below, the generation of the potential next tokens 109 and associated probabilities may be executed within one or more attention heads, e.g., using a final attention layer of one or more attention heads, of the second large language model 106.

Process 200 includes determining a first perplexity score for the first potential next token with respect to the first output and a second perplexity score for the second potential next token with respect to the first output (206). For example, the perplexity adjustment mechanism 108 may use Equation 1, or similar equation, to calculate a perplexity score for “The man from Germany spoke German,” for “The man from Germany spoke French,” and for “The man from Germany spoke English,” as in the examples above in which the first or partial output 107 is “The man from Germany spoke” and the potential next tokens 109 include “German,” “French,” and “English.”

Process 200 includes selecting the first potential next token as a next token, based on the first perplexity score and the second perplexity score (208). For example, in FIG. 1, the perplexity adjustment mechanism 108 may output perplexity adjustments 110 to be used to adjust corresponding probabilities (e.g., attention weights) of each of the potential next tokens within the second large language model 106. The second large language model 106 may then select one of the potential next tokens, referenced at the first potential next token in FIG. 2, based at least in part on the perplexity-adjusted attention weights of each of the potential next tokens. In particular, as described, the perplexity-adjusted attention weights may be adjusted so that the second large language model 106 may select a next token from the potential next tokens 109 with greater confidence.

Process 200 includes providing a second output from the language model that includes the next token appended to the first output (210). For example, in FIG. 1, the second large language model 106 may output the perplexity guided output 112 as a combination of the partial output 107 and a selected one of the potential next tokens 109.

Process 200 may continue iteratively for a series of outputs of the second large language model, until a final output is reached. The perplexity calculations of Equation 1 include simply arithmetical calculations that may be performed quickly and with a minimum of processing and memory resources, relative to the processing and memory resources already required for operations of the second large language model 106. As a result, and as described herein, the system and process of FIGS. 1 and 2 may be used to increase an accuracy of outputs of the second large language model 106, without requiring additional training or training data, and without appreciably slowing or otherwise hindering operations of the second large language model 106 at inference time.

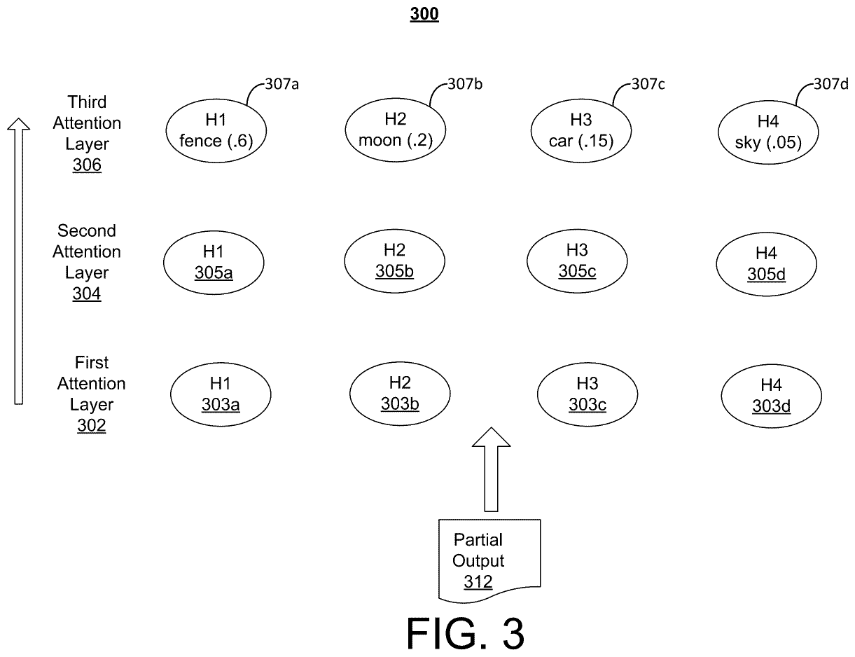

FIG. 3 is an example schematic of a large language model 300 with attention heads. For example, the large language model 300 may use a transformer architecture with an encoder and a decoder having multiple attention layers with each attention layer having multiple attention heads. The large language model 300 with the multiple attention layers may be the type of architecture used for the first large language model 104 and the second large language model 106.

In this simplified example, the large language model 300 includes a first attention layer 302, a second attention layer 304, and a third attention layer 306. Input data is processed by each of the attention layers, the first attention layer 302, the second attention layer 304, and the third attention layer 306. Each of the attention layers includes multiple attention heads.

For example, the first attention layer 302 includes attention heads H1 303a, H2 303b, H3 303c, and H4 303d. The second attention layer 304 includes attention heads H1 305a, H2 305b, H3 305c, and H4 305d. The third attention layer 306 includes attention heads H1 307a, H2 307b, H3 307c, and H4 307d. As the partial output 312 is processed by the first attention layer 302, the second attention layer 304, and the third attention layer 306, the attention heads within each of the layers are assigned an attention score.

For instance, an initial prompt may be the query “what did the dog do?”, which may be processed as described with respect to FIG. 1 to determine a partial output 312 of “The dog went under the”. The output of the large language model 300 is then to predict the next word. In this example, the large language model 300 may be an example of the second large language model 106 of FIG. 1.

In this example, the first attention layer 302 and the second attention layer 304 may capture key context of the partial output 312, and the third attention layer 306 may generate potential next words with an associated probability distribution assigning a probability of selection to each word. In the example, the third attention layer 306 includes a potential next word “fence” with a 0.6 probability at attention head 307a, a potential next word “moon” with a 0.2 probability at attention head 307b, a potential next word “car” with a 0.15 probability at attention head 307c, and a potential next word “sky” with a 0.05 probability at attention head 307d.

FIG. 3 is a simplified example for the sake of illustration. In more detail, and in more specific examples, a large language model may output logits for potential next tokens. For example, logits for the potential next tokens of “fence,” “moon,” “car,” and “sky” may be assigned as 2.5, 1.2, 1.0, and 0.8, respectively. A softmax function may then be used to determine the above-provided respective probabilities of 0.6, 2, 0.15, and 0.05.

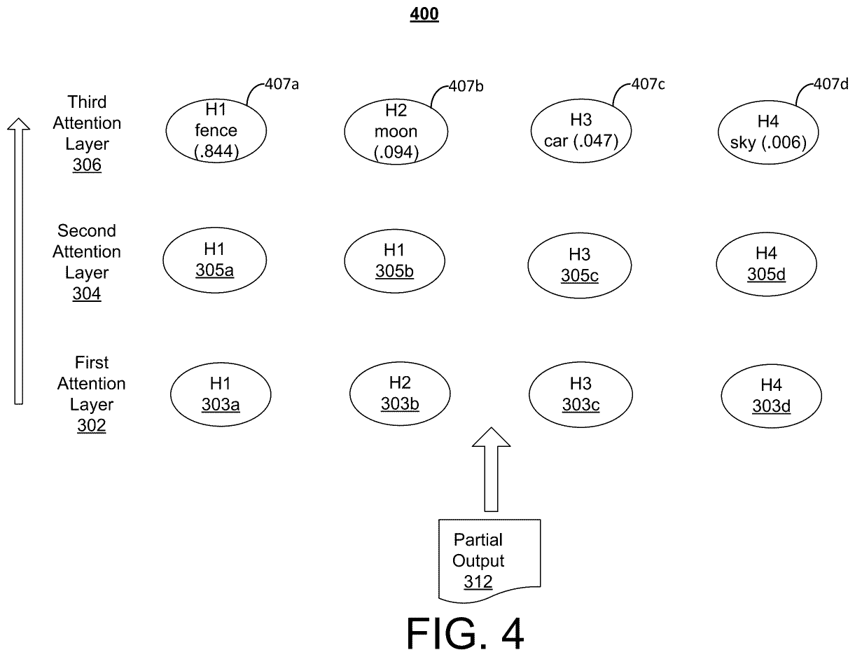

FIG. 4 is an example schematic of a large language model with attention heads having perplexity-adjusted probabilities. For example, Equation 1 above, or a similar equation for calculating perplexity, may be used to calculate a perplexity score for “The dog went under the fence” of 1.67, where this perplexity score results from the probability of 0.6 previously determined for fence, along with probability scores (and associated attention weights) of the partial output 312 of “The dog went under the”, where such probabilities are not shown here for the sake of brevity. Similar calculations may be performed to find token-specific or word-specific perplexity scores for each of the remaining potential next tokens and/or words of “moon,” “car,” and “sky,” to obtain corresponding perplexity scores of 5, 6.67, and 20, respectively.

In the preceding perplexity scores, higher score values for a sequence of tokens are associated with greater uncertainty, lower probability, and lower confidence for the sequence. Thus, in the example, “sky” has the lowest probability and highest perplexity. Therefore, in order to adjust attention weights of the third attention layer 306, the calculated perplexity scores are inverted. Inverted perplexity scores are thus obtained for “fence,” “moon,” “car,” and “sky,” as 1/1.67=0.6, 1/5=2, 1/6.67=0.15, and 1/20=. 0.05, respectively.

In the example of FIG. 4, adjusted attention weights may be obtained by multiplying the original attention weights (based on probabilities) by the inverted perplexity scores. Adjusted attention weights are thus obtained for “fence,” “moon,” “car,” and “sky,” as 0.6*0.6=0.36, 2*2=0.04, 0.15*15=0.02, and 0.05*0.05=0.0025, respectively.

These adjusted weights may then be normalized to obtain normalized adjusted weights. For example, a total value of 0.36+0.04+0.02+0.0025 equals approximately 0.4265, yielding normalized probabilities for “fence” of 0.36/0.4265 equaling approximately 0.844, for “moon” of 0.04/0.4265 equaling approximately 0.094, for “car” of 0.02/0.4265 equaling approximately 0.047, and for “sky” of 0.0025/0.4265 equaling approximately 0.006.

Thus, these normalized probabilities, reflecting adjusted attention weights, are illustrated in corresponding attention heads 407a, 407b, 407c, and 407d of FIG. 4. As may be observed, these normalized probabilities have a distribution that is considerably more shifted towards the potential next token of “fence.” Consequently, the large language model 400 of FIG. 4 may more easily and more definitively select “fence” as an actual next token for output, so that the large language model 400 is more likely to generate desirable outputs and less likely to hallucinate erroneous, incorrect, or otherwise undesirable outcomes.

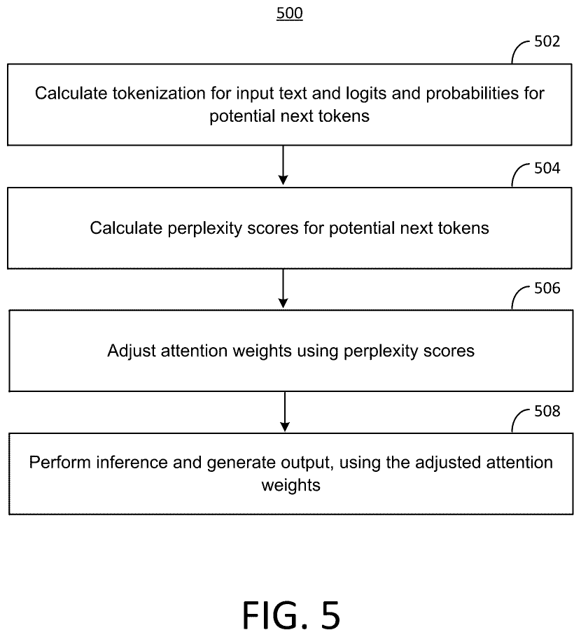

FIG. 5 is a flowchart illustrating more detailed example implementations of the system of FIG. 1. FIG. 5 also provides further example details regarding the example calculations of FIGS. 3 and 4. Some aspects of such details are known in the art and are not discussed here, and would be apparent to those of skill in the art.

In FIG. 5, process 500 includes calculating tokenization for input text and logits and probabilities for potential next tokens (502), in which input text is tokenized to obtain unique identifiers for a token (token IDs). The token IDs are then fed through a large language model to obtain a (tokenized) partial output that is iteratively processed by the large language model to determine logits for potential next tokens, which are then processed using a softmax function to determine corresponding probabilities, as described above with respect to FIG. 3.

Process 500 includes calculating perplexity scores for potential next tokens (504). As described above, e.g., with respect to FIGS. 3 and 4, gathered or aggregated probabilities of the partial output may be used in conjunction with each probability of each potential next token to determine each corresponding perplexity score.

Process 500 includes adjusting attention weights using perplexity scores (506), in which attention weights of a final attention layer of the large language model are adjusted, using the perplexity scores. In specific examples, hidden states are obtained from the large language model and then concatenated with inverses of the perplexity scores. Then, attention weights may be calculated by applying a linear layer and sigmoid function. For example, the linear layer may be used to transform high-dimensional representations produced by the model into logits of the size of the vocabulary. Resulting adjusted attention weights may then be normalized.

Process 500 includes performing inference and generating output, using the adjusted attention weights (508), in which inference is performed using the adjusted attention weights to generate a final output. For example, the adjusted attention weights may be used to calculate a weighted sum of hidden states, to thereby obtain a context vector. The context vector may then be fed through the large language model head to obtain output logits (and thus probability distribution) for the next token prediction. As described, the probability distribution is improved and less likely to result in hallucination by the large langue model, due to the use of the calculated perplexity scores. Thus, during inference, the model dynamically adjusts its attention weights based on the perplexity scores of tokens in a generated sequence, prioritizing tokens that are more predictable and contextually relevant.

Described techniques may be validated with respect to hallucination reduction and/or used to detect hallucination in existing models. For example, after computing perplexity scores as described above from attention weights, logits, and corresponding probabilities obtained using a softmax function (referred to here as first perplexity score(s)). Then, a second perplexity score may be computed as a ratio of the first perplexity score to an average of a baseline perplexity score(s) for the model in question, using known data that does not produce hallucination. A third perplexity score for perplexity guided attention weights may be computed by comparing low logit token probability with attention scores and average scores. For example, various known techniques (e.g., Kullback-Leibler divergence (KL)) may be used to relate how different two distributions are between logits and attention weights. Accordingly, anomalies in which a logit is low while attention is high (or vice-versa) may be determined.

The above procedures may be used with ground truth data and a synthetically hallucinated dataset to train a second large language model. This second large language model may then take inputs of attention weights, logits, and the three types of perplexity scores to predict either hallucination or the absence of hallucination. In the example described above, the second large language model may be used to capture relationships between the four perplexity scores and detect likely hallucinations.

The terminology used herein is for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example implementations.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer-implemented method comprising:
processing a prompt at a language model to generate a first output in response to the prompt;
determining, for the first output, at least a first potential next token and a second potential next token;
determining a first perplexity score for the first potential next token with respect to the first output and a second perplexity score for the second potential next token with respect to the first output;
selecting the first potential next token as a next token, based on the first perplexity score and the second perplexity score; and
providing a second output from the language model that includes the next token appended to the first output.

2. The method of claim 1, wherein the language model is a fine-tuned, domain-specific large language model.

3. The method of claim 1, wherein the first output includes a sequence of tokens, and wherein the first perplexity score is calculated by taking an exponential of negative log probabilities of the sequence of tokens and the first potential next token.

4. The method of claim 1, comprising:
adjusting attention weights of the language model using the first perplexity score.

5. The method of claim 4, comprising:
adjusting the attention weights using an inverse of the first perplexity score.

6. The method of claim 1, comprising:
determining, for the first potential next token, a first logit; and
determining, for the second potential next token, a second logit.

7. The method of claim 6, comprising:
determining a first probability of selection for the first potential next token from the first logit; and
determining a second probability of selection for the second potential next token from the second logit.

8. The method of claim 7, comprising:
determining the first perplexity score using the first probability; and
determining the second perplexity score using the second probability.

9. A computer program product, the computer program product being tangibly embodied on a non-transitory computer-readable medium and comprising instructions that, when executed by at least one computing device, are configured to cause the at least one computing device to:
process a prompt at a language model to generate a first output in response to the prompt;
determine, for the first output, at least a first potential next token and a second potential next token;
determine a first perplexity score for the first potential next token with respect to the first output and a second perplexity score for the second potential next token with respect to the first output;
select the first potential next token as a next token, based on the first perplexity score and the second perplexity score; and
provide a second output from the language model that includes the next token appended to the first output.

10. The computer program product of claim 9, wherein the first output includes a sequence of tokens, and wherein the first perplexity score is calculated by taking an exponential of negative log probabilities of the sequence of tokens and the first potential next token.

11. The computer program product of claim 9, wherein the instructions, when executed, are further configured to cause the at least one computing device to:
adjust attention weights of the language model using the first perplexity score.

12. The computer program product of claim 11, wherein the instructions, when executed, are further configured to cause the at least one computing device to:
adjust the attention weights using an inverse of the first perplexity score.

13. The computer program product of claim 9, wherein the instructions, when executed, are further configured to cause the at least one computing device to:
determine, for the first potential next token, a first logit; and
determine, for the second potential next token, a second logit.

14. The computer program product of claim 13, wherein the instructions, when executed, are further configured to cause the at least one computing device to:
determine a first probability of selection for the first potential next token from the first logit; and
determine a second probability of selection for the second potential next token from the second logit.

15. The computer program product of claim 14, wherein the instructions, when executed, are further configured to cause the at least one computing device to:
determine the first perplexity score using the first probability; and
determine the second perplexity score using the second probability.

16. A system comprising:
at least one memory including instructions; and
at least one processor that is operably coupled to the at least one memory and that is arranged and configured to execute instructions that, when executed, cause the at least one processor to:
process a prompt at a language model to generate a first output in response to the prompt;
determine, for the first output, at least a first potential next token and a second potential next token;
determine a first perplexity score for the first potential next token with respect to the first output and a second perplexity score for the second potential next token with respect to the first output;
select the first potential next token as a next token, based on the first perplexity score and the second perplexity score; and
provide a second output from the language model that includes the next token appended to the first output.

17. The system of claim 16, wherein the first output includes a sequence of tokens, and wherein the first perplexity score is calculated by taking an exponential of negative log probabilities of the sequence of tokens and the first potential next token.

18. The system of claim 16, wherein the instructions, when executed, are further configured to cause the at least one processor to:
adjust attention weights of the language model using an inverse of the first perplexity score.

19. The system of claim 16, wherein the instructions, when executed, are further configured to cause the at least one processor to:
determine, for the first potential next token, a first logit; and
determine, for the second potential next token, a second logit.

20. The system of claim 19, wherein the instructions, when executed, are further configured to cause the at least one processor to:
determine a first probability of selection for the first potential next token from the first logit; and
determine a second probability of selection for the second potential next token from the second logit;
determine the first perplexity score using the first probability; and
determine the second perplexity score using the second probability.
